(19) United States
(12) Patent Application Publication
(10) Pub. No.: US 2013/0266839 A1
(43) Pub. Date: Oct. 10, 2013

(54) THERMAL CONDUCTIVE MECHANISM FOR BATTERY PACK MADE UP OF STACK OF BATTERY MODULES

(71) Applicant: DENSO CORPORATION, Kariya-city (JP)

(72) Inventors: Kouji MIURA, Okazaki-shi (JP); Teruhiko KAMEOKA, Okazaki-shi (JP); Masaya NAKAMURA, Nagoya (JP); Shun OHKIJIMA, Anjo-shi (JP); Ryuichiro SHINKAI, Kariya-shi (JP); Kouhei YAMAGUCHI, Kariya-shi (JP); Masaki UCHIYAMA, Sagebrush Novi, MI (US); Narito HIRAKIDA, Chita-gun (JP); Kazuhiro TOKONAMI, Handa-shi (JP); Michihiko MORITA, Chiryu-shi (JP); Hiroshi KONDO, Kariya-shi (JP)

(73) Assignee: DENSO CORPORATION, Kariya-city (JP)

(21) Appl. No.: 13/846,588

(22) Filed: Mar. 18, 2013

(30) Foreign Application Priority Data
Apr. 10, 2012 (JP) 2012-089704

(51) Int. Cl. H01M 10/50

(52) U.S. Cl. CPC H01M 10/50
USPC 429/120

(57) ABSTRACT

A thermal conductive mechanism for a battery pack made up of a stack of a plurality of sub-battery modules each of which includes a plurality of battery cells arrayed thereon. The sub-battery modules each has opposed major surfaces and are laid to overlap each other in a direction perpendicular to the major surfaces. The thermal conductive mechanism is equipped with plates provided one for each of the sub-battery modules. Each of the plates has a given number of the battery cells disposed thereon and also has heat transfer surfaces extending in a planar direction of the plate. The heat transfer surfaces are placed in one of direct and indirect contact with the given number of the battery cells to achieve transfer of heat therebetween, thereby equalizing the temperature in each of the battery cells and also minimizing a difference in temperature among the battery cells.

### CROSS REFERENCE TO RELATED DOCUMENT

The present application claims the benefit of priority of Japanese Patent Application No. 2012-89704 filed on Apr. 10, 2012, disclosure of which is incorporated herein by reference.

### BACKGROUND OF THE INVENTION

1. Technical Field

This disclosure relates generally to a thermal conductive mechanism for a battery pack made up of a plurality of battery modules.

2. Background Art

Japanese Patent First Publication No. 2004-031281 teaches an example of techniques of improving a cooling mechanism of an electrode stack type battery pack which is designed to press both sides of each battery cell and enhance the cooling ability without having to increase the number of components thereof. Specifically, the cooling mechanism is equipped with pairs of press plates, each pair pressing the side surfaces of each of the battery cells with portions extending outside the periphery of the battery cell to facilitate dissipation of heat from the battery cell.

In general, the performance of the battery cell depends upon the temperature thereof. The achievement of full performance (e.g., charging or discharging) of the battery cell, therefore, requires keeping the temperature of each battery cell or the whole of the battery pack constant. The above cooling mechanism of the battery pack uses the portions of the press plates extending outside each of the battery cells as a heat dissipator, thus causing a peripheral portion of the battery cell close to the heat dissipator to be cooled greatly, while a central portion of the battery cell is hardly cooled. This results in a difference in temperature between the peripheral portion and the central portion of the battery cell, which leads to a difficulty in delivering the performance of the battery pack fully.

### SUMMARY

It is therefore an object to control a difference in temperature among a plurality of battery cells for improving the performance of a battery pack.

It is another object is to minimize a difference in temperature between a peripheral and a central portion of a battery cell to enhance the performance of a battery pack.

According to one aspect of the invention, there is provided a thermal conductive mechanism for a battery pack. The battery pack is made up of a stack of a plurality of sub-battery modules each of which includes a plurality of battery cells arrayed thereon. The sub-battery modules each have opposed major surfaces and are laid to overlap each other in a direction perpendicular to the major surfaces. The thermal conductive mechanism comprises: (a) plates provided one for each of the sub-battery modules, each of the plates having a given number of the battery cells disposed thereon; and (b) heat transfer surfaces formed on each of the plates and arrayed in a planar direction of the plates. The heat transfer surfaces are placed in one of direct and indirect surface-contact with the given number of the battery cells to achieve transfer of heat therebetween.

Specifically, the battery cells of each of the sub-battery modules are arrayed in the planar direction. The plate may be in indirect or direct contact with surfaces of the battery cells which extend in the planar direction. Each of the plates works to achieve the transfer of heat to or from the battery cells, thus minimizing a difference in temperature between the battery cells, which will improve the performance of the battery pack.

Each of the battery cell may be implemented by a primary cell, a secondary or rechargeable cell, or a fuel cell. The planar direction may be a direction parallel to the widest surface (i.e., a major surface) of each of the battery cells. The widest surface is the surface having the greatest area in each of the battery cells. The sub-battery modules are, as described above, laid to overlap each other in the direction perpendicular to the major surfaces. The sub-battery modules may be placed in either direct or indirect contact with each other. The plate is made of a thermally conductive material such as metal or graphite. The transfer of heat is to cool or warm the battery cells.

The thermal conductive mechanism may also include a heat exchanger placed in direct or indirect contact with surfaces of the battery cells other than surfaces with which the heat transfer surfaces are in direct or indirect contact. The heat exchanger works to keep all of the battery cells at a desired temperature, thus ensuring full performance of the battery pack.

The heat exchanger may work as a cooler or a heater.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a perspective view which illustrates a sub-battery module with a thermal conductive mechanism according to a first embodiment;

FIG. 2 is a partially perspective view which illustrates how to amount a battery cell on a plate;

FIG. 3 is a sectional view, as taken along the line in FIG. 4, which illustrates a sub-battery module in the first embodiment;

FIG. 4 is a plan view which illustrates a sub-battery module in the first embodiment;

FIG. 5 is transverse sectional view, as taken along the line V-V in FIG. 4;

FIG. 6 is a perspective view which illustrates a battery module in the first embodiment;

FIG. 7 is an enlarged exploded perspective view which illustrates heat-transfer mechanisms mounted in a sub-battery module in the first embodiment;

FIG. 8 is an exploded perspective view which illustrates a battery pack in the first embodiment;

FIG. 9 is a perspective view which illustrates heat transferring members for sub-battery modules in the first embodiment;

FIG. 10 is an exploded perspective view which shows a binding mechanism to bind sub-battery modules into a stack;

FIG. 11 is a plan view which demonstrates heat transferring paths when a heat exchanger works to cool battery cells;

FIG. 12 is a plan view which demonstrates heat transferring paths when a heat exchanger works to warm battery cells;

FIG. 13 is a plan view which shows a battery module in the second embodiment;

FIG. 14 is a perspective view which illustrates a sub-battery module with sheets disposed between a plate and battery cells;

FIG. 15 is transverse sectional view, as taken along the line V-V in FIG. 4, in a case where sheets are disposed between a plate and battery cells; and

FIG. 16 is an exploded perspective view which illustrates a battery module having a heat exchanger placed in direct contact with plates of-battery modules.

### DESCRIPTION OF THE PREFERRED EMBODIMENTS

Embodiments will be described below with reference to drawings. Note that “connection”, as referred to in the following discussion, means “electric connection” although not specified. Each drawing illustrates components required only for explanation of each embodiment and does not necessarily show all components making up the embodiment. “upper”, “lower”, “right”, and “left”, as referred to in the following discussion, are based on each drawing. “contact” means either of “direct contact” or “indirect contact”. “hole” means either of “through hole” or “cut-out portion”.

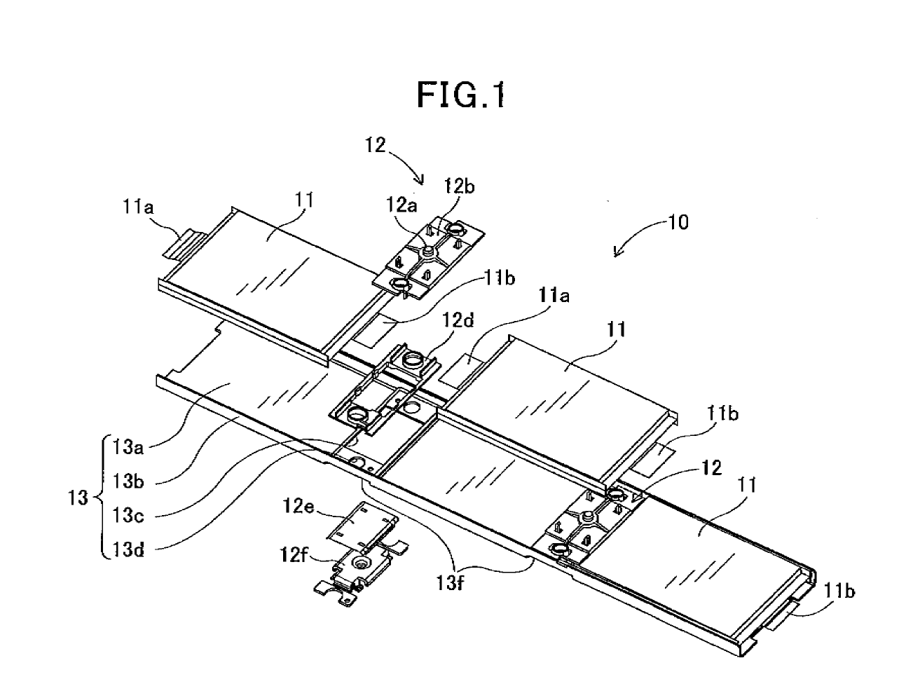

The first embodiment will be discussed below with reference to FIGS. 1 to 10. FIG. 1 illustrates a sub-battery module 10 which includes a plurality of (three in this embodiment) battery cells 11, heat-transfer mechanisms 12, a plate 13.

The battery cells 11 are arrayed on the plate 13 in alignment with each other in a lengthwise direction of the plate 13. Each of the battery cells 11 is an electric cell consisting of an electrolyte and a separator and is equipped with terminals 11a and 11b for charging or discharging. The terminals 11a and 11b serve as joints. One of the terminals 11a and 11b is a plus (i.e., positive) terminal, and the other is a minus (i.e., negative) terminal. The terminals 11a and 11b may be each implemented by an electrode, a pin, a lead, or a bus bar.

Each of the battery cells 11 is a laminated lithium-ion battery. The material of a positive electrode (i.e., a cathode active material) of the laminated lithium-ion battery is a polyanionic material such as LiMPO₄ or LiMSiO₄ and contains as a metallic element (M) one or more of manganese (Mn), ion (Fe), cobalt (Ca), and Nickel (Ni).

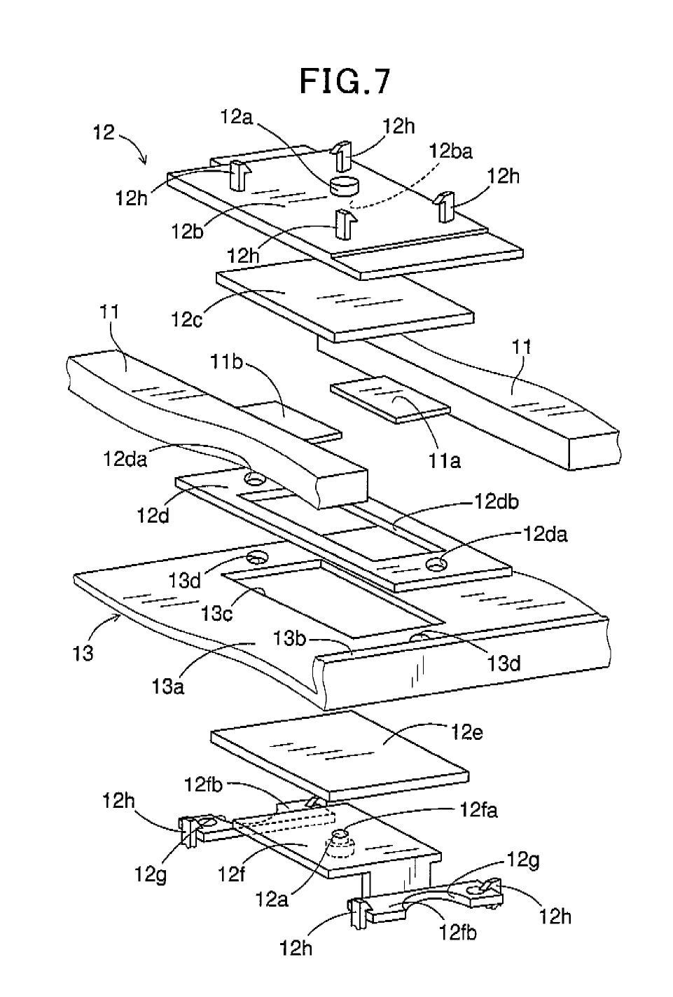

Each of the heat-transfer mechanisms 12 serves to achieve conduction of heat among the plate 13 and the terminals 11a and 11b (i.e., joints between the battery cells 11). Specifically, each of the heat-transfer mechanisms 12 works to either or both warm and cool the battery cells 11. The structure of the heat-transfer mechanisms 12 will be described later in detail with reference to FIG. 7.

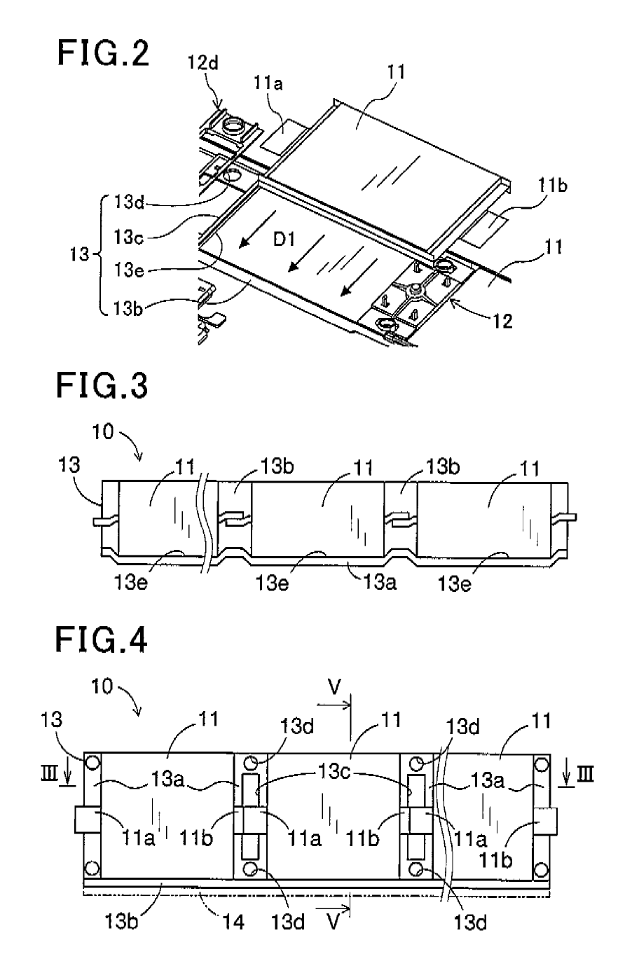

The plate 13 illustrated in FIGS. 2 to 5 is designed as a thermal conductive mechanism to be in direct or indirect surface-contact with horizontal flat surfaces of the battery cells 11 to transfer the heat therebetween and also to achieve, as described above, the heat transfer to or from the terminals 11a and 11b through the heat-transfer mechanisms 12. It is, thus, advisable that the plate 13 be made of high-thermal conductive material such as copper or aluminum. The plate 13 has recesses 13e by which the battery cells 11 are positioned on the plate 13. FIG. 3 illustrates the battery cells 11 after mounted in place on the plate 3. FIG. 3 is a sectional view, as taken along the line III-III in FIG. 4, from which hatching is emitted.

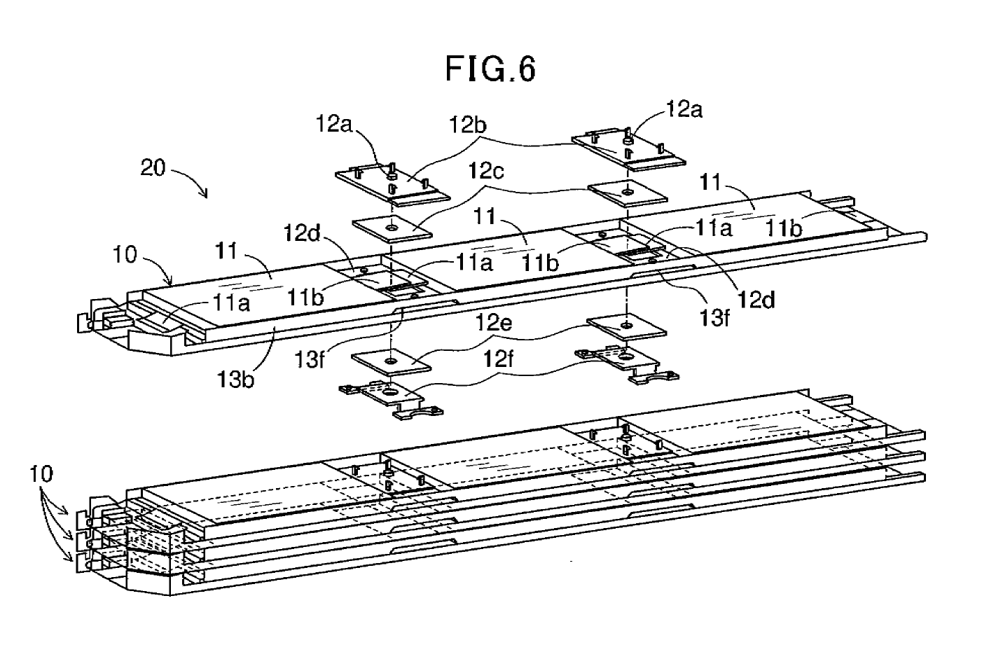

The plate 13 includes a body 13a, a thermal conductive wall 13b, first holes 13c, second holes 13d, the recesses 13e, and recesses 13f, as can be seen in FIGS. 1 and 6. The body 13a is shaped to achieve the transfer of heat between itself and flat surfaces of the battery cells 11. The body 13a may be made of any material as long as it establishes such heat transfer. The material of the body 13a may be identical with, or different from that of the thermal conductive wall 13b. The body 13a has formed therein, as illustrated in FIG. 3, as many recesses 13e as the battery cells 11 which are mounted on the plate 13.

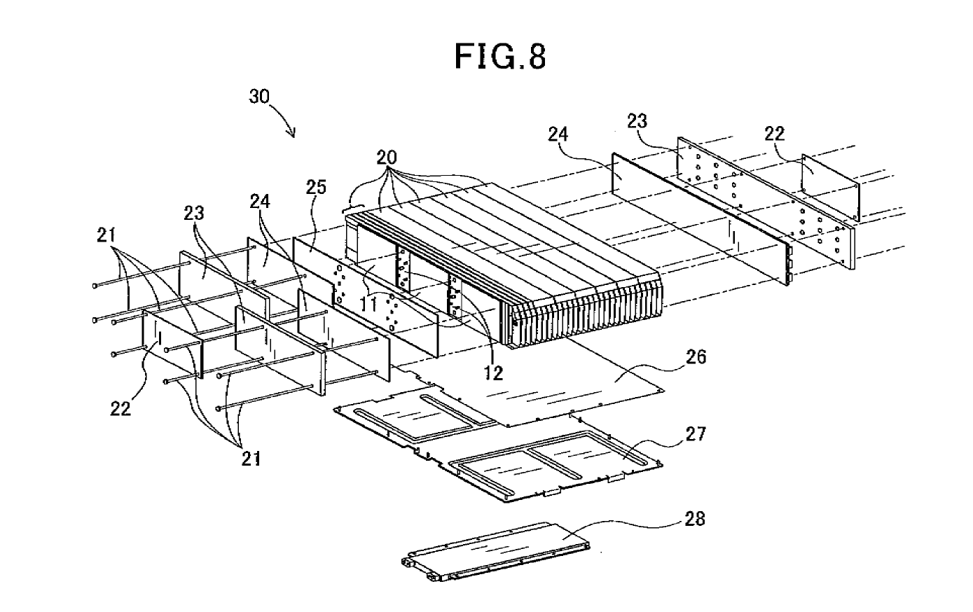

The thermal conducive wall 13b is in direct or indirect surface-contact with a heat exchanger 28, as will be described later with reference to FIG. 8, to transfer heat therebetween. In the case where the heat exchanger 28 is used as a cooling mechanism, the heat will move along a heat-transferring path, as indicated by arrows D1 in FIG. 2. The thermal conductive wall 13b may be made of any material as long as it achieves such heat transfer. It is, however, advisable that the thermal conductive wall 13b be made of high-thermal conductive material.

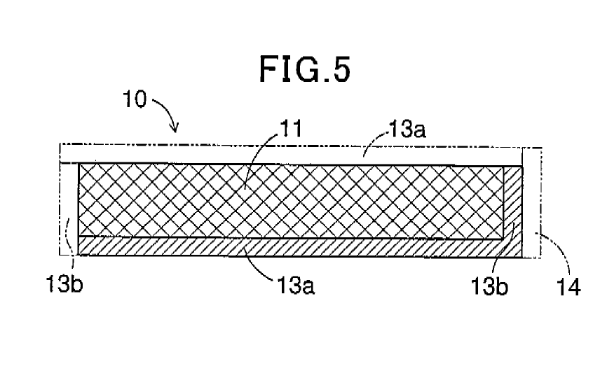

The body 13a and the thermal-conductive wall 13b may be made in any known manner. In this embodiment, the formation of the body 13a and the thermal-conductive wall 13b is achieved by pressing or bending a single plate member into an L-shape in transverse cross section, as illustrated in FIG. 5. The body 13a, as illustrated in FIG. 5, has a major surface placed in contact with a lower surface of each of the battery cells 11. The thermal-conductive wall 13b has a major surface placed in contact with a right side surface, as viewed in the drawing, of each of the battery cells 11. The body 13a may alternatively be, as indicated by a two-dot chain line in FIG. 5, placed in contact with an upper surface of each of the battery cells 11, while the thermal-conductive wall 13b may be placed in contact with a left side surface of each of the battery cells 11. The sub-battery module 10 may also alternatively be shaped to have two bodies 13a placed in contact with the opposed major surfaces of each of the battery cells 11 and two thermal-conductive walls 13b placed in contact with the opposed side surfaces of each of the battery cells 11.

The first holes 13c are through holes or windows formed in portions of the plate 13 which coincide with the terminals 11a and 11b of the respective battery cells 11 in a thickness-wise direction of the sub-battery module 10 (i.e., the battery cells 11). The first holes 13c are used in joining the terminal 11b of one of the battery cells 11 to the terminal 11a of an adjacent one of the battery cells 11 using a joining machine such as an ultrasonic welder or a spot welder. The shape of the first holes 13c is not limited to rectangular, but may be polygonal, such as triangular or pentagonal, round, such as circular or oval, or a combination of two or more of them.

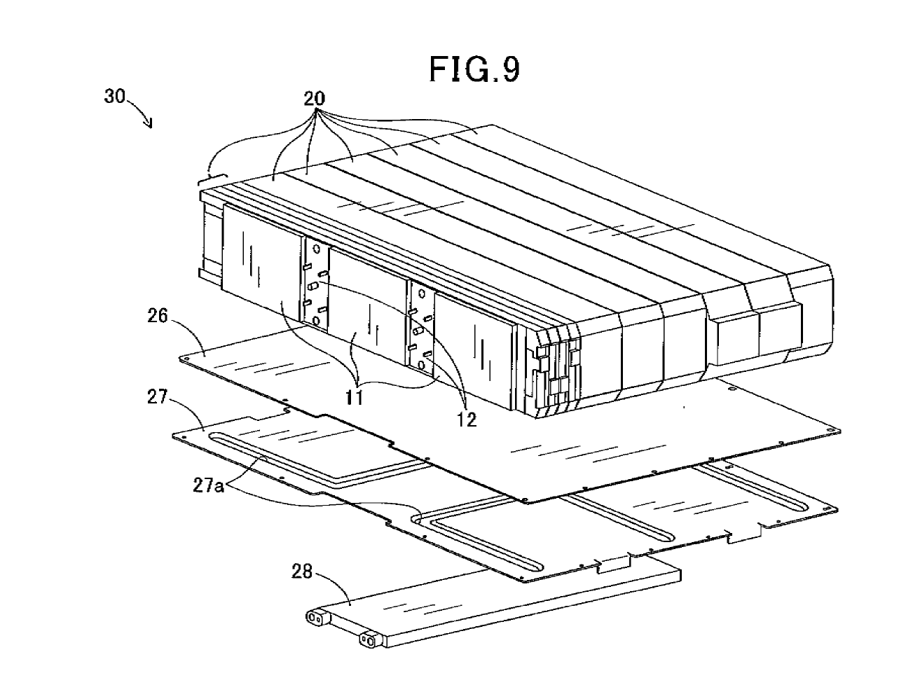

The second holes 13d are through holes formed in the plate 13 through which binding members 21 are as illustrated in FIGS. 8 and 9, to be inserted. The second holes 13d is not limited in shape to circular, but may be in any other form as long as they permit the binding members 21 to pass therethrough.

The recesses 13f define chambers in which components 12d and 12f of the heat-transfer mechanisms 12, which will be described later in detail, are disposed. In other words, the recesses 13f defines surfaces, preferably flat surfaces on the plate 13 which function as heat-transfer surfaces and are placed in direct or indirect contact with the surfaces of the battery cells 11, respectively, to achieve the transfer of heat therebetween. Each of the recesses 13f is not limited in shape to trapezoidal, but may be in any other form as long as the components 12d and 12f are located beneath or outside the lower surface of the plate 13.

The sub-battery module 10 may be as illustrated by a two-dot chain line in FIGS. 4 and 5, equipped with a heater 14 attached in surface-contact with the plate 13. The heater 14 works to warm the battery cells 11 up and may be made of a heat emitting material or device. For example., the heater 14 may be implemented by a PCT heater or a carbon heater. In the case of use of the heater 14, the heat exchanger 28, as will be described later with reference to FIG. 8, may be used as a cooler.

The structure of each of the heat-transfer mechanisms 12 will be described below with reference to FIGS. 6 and 7. FIG. 6 illustrates an example of each of the sub-battery modules 10 which is equipped with the two heat-transfer mechanisms 12. FIG. 7 is an enlarged exploded view which illustrates the heat-transfer mechanisms 12.

The heat-transfer mechanism 12 consists essentially of a boss or protrusion 12a, insulating resinous plates 12b and 12d, a thermal conductive member 12f, a damping plate 12c, and an insulating cover 12e. The insulating resinous plates 12b and 12d and the insulating cover 12e each serve as an electric insulator. The insulating resinous plates 12b and 12d and the insulating cover 12e are, as can be seen in the drawing, interposed between the plate 13 and adjacent two (i.e., the joint) of the terminals 11a and 11b and made of an insulating resin material.

The insulating resinous plate 12d has a hole or window 12bd for use in joining the terminals 11a and 11b. The window 12bd may be identical with or different in shape from the first holes 13c.

The damping plate 12c is made totally or partially of an elastic material and works as a damper or vibration absorber to suppress mechanical vibration of the terminals 11a and 11b. Such vibration arises from the actuation of an object, as will be described later in detail, or a device (e.g., a vehicle) on or in which battery modules 20 or a battery pack 30 are mounted. The elastic material may be resin or rubber exhibiting elasticity or a plate spring. The insulating cover 12e serves as a protector to protect the terminals 11a and 11b from impact. The damping plate 12c and the insulating cover 12e may be made of same or different materials.

The thermal conductive member 12f works to enhance the transfer of thermal energy between the plate 3 and the terminals 11a and 11b. The thermal conductive member 12f is preferably made of a high-thermal conductive material such as copper or aluminum.

The insulating resinous plate 12d also has third holes 12da extending through a thickness thereof. The thermal conductive member 12f also has third holes 12g each of which is formed by a semicircular hole or a cut-out. The third holes 12da and 12g coincide with the second holes 13d in the thickness-wise direction of the heat-transfer mechanism 12 so that the binding members 21 may pass through the third holes 12da and 12g.

The insulating resinous plate 12b has formed thereon the protrusion 12a and hooks 12h with barbed heads. The protrusion 12a and the hooks 12h serve as fasteners. The thermal conductive member 12f also has a fastening hole 12fa and fastening plates 12fb. The hooks 12h project or extend from the major surface of the insulating resinous plate 12b. The hooks 12h, as clearly illustrated in a lower portion of FIG. 7, engage or snap-fit on the fastening plates 12fb of the thermal conductive member 12f.

The battery module 20, as illustrated in FIG. 6, is made up of, for example, the four sub-battery modules 10 which are stacked in layers, in other words, laid to overlap each other in the thickness-wise direction thereof (i.e., a direction perpendicular to the flat major surfaces of the sub-battery modules 10). The body 13a of each of the sub-battery modules 10 is placed in surface-contact with adjacent two of the battery cells 11 which are laid to overlap each other in the vertical direction (i.e., the thickness-wise direction of the sub-battery modules 10, thereby establishing the transfer of heat to or from the battery cells 11 Each of the sub-battery modules of FIG. 6 does not have an upper one of the bodies 13a, as illustrated by a two-dot chain line in FIG. 5.

A battery device made up of a stack of the battery modules 20 (e.g., the seven battery modules 20 in this embodiment) will be described below with reference to FIGS. 8 to 10. FIGS. 8 to 10 are perspective views. For the convenience of explanation, lower left portions of FIGS. 8 to 10 will be referred to as a front side, while upper right portions thereof will be referred to as a rear side. Connections of the battery device to an external device, and a film or a cover which covers upper surfaces of the battery modules 20 will be omitted for the brevity of illustration.

FIG. 8 illustrates the battery pack 30 as the battery device which consists essentially of the battery modules 20, the binding members 21, binding plates 22, end plates 23, intermediate plates 24, a protective plate 25, heat-transfer plates 26 and 27, and the heat exchanger 28.

Each of the battery modules 20 is made of the sub-battery modules 10 laid to overlap each other in the thickness-wise direction thereof. Similarly, the battery pack 30 is made of the battery modules 20 laid to overlap each other in the same direction as the direction in which the sub-battery modules 10 are stacked. FIGS. 8, 9, and 10 show a front one of the battery modules 20 from which a cover is removed and the other battery modules 20 equipped with covers.

The protective plate 25 is placed in surface-contact with an end surface of the stack of the battery modules 20 (i.e., the surfaces of the battery cells 11 disposed in a front one of the sub-battery modules 10). Specifically, the battery cells 11 of the other sub-battery modules 10 are covered with the plates 13, while the battery cells 11 disposed on the front sub-battery 10 are not closed by the plate 13 (see FIGS. 3 to 5), but by the protective plate 25. In the case where the battery modules 20 include the sub-battery module 10, as illustrated in FIG. 5, which is equipped with the body 13a, as indicated by the two-dot chain line, the protective plate 25 is not necessary because the above body 13a serves as a protector for the battery cells 11.

The binding plate 22, the end plates 23, and the intermediate plates 24 are disposed in this order in a direction from the front to the rear of the battery pack 30. Similarly, the binding plate 22, the end plates 23, and the intermediate plates 24 are disposed in this order in a direction from the rear to the front of the battery pack 30. Note that the one intermediate plate 24 and the one end plate 23 are shown on the rear side of the battery pack 30 for the brevity of illustration. Specifically, the total of two binding plates 22, the total of four end plates 23, and the total of four intermediate plates 24 are disposed on the ends of the battery pack 30. The number, material, or geometrical configuration of the binding plate 22, the end plates 23, and the intermediate plates 24 is not limited to the illustrated one.

The binding members 21, as can be seen in FIG. 9, bind the battery modules 20 into a stack along with the binding plates 22, the end plates 23, the intermediate plates 24, and the protective plate 25. In this embodiment the eight binding members 21 are used, but the number thereof may be changed as necessary. Each of the binding members 21 may be implemented by a fastening member such as a pin.

The heat-transfer plates 26 and 27 and the heat exchanger 28 are disposed on the lower surface of the stack of the battery modules 20. The heat-transfer plates 26 and 27 are each made of material which is identical in thermal conductivity with or higher than that of the plate 13. The heat-transfer plate 27 has E-shaped grooves 27a in order to enhance the mechanical strength thereof. The heat-transfer plates 26 and 27 work to facilitate the transfer of heat between the battery cells 11 and the heat exchanger 28.

Each of the plate 13, as described already, has the thermal conductive wall 13b. The thermal conductive walls 13b are in surface-contact with the heat-transfer plate 26. In other words, the thermal conductive walls 13b are placed in indirect surface-contact with the heat exchanger 28, thereby resulting in uniformity of temperature over the whole of each of the battery cells 11 and among all the battery cells 11.

The heat exchanger 28 may be implemented by either of a cooler or a heater or designed to have pipes through which fluid (gas or liquid) flows. When fluid lower in temperature than the battery cells 11 is passed through the pipe of the heat exchanger 28, the heat exchanger 28 works as a cooler. Conversely, when fluid higher in temperature than the battery cells 11 is passed through the pipe of the heat exchanger 28, the heat exchanger 28 works as a heater.

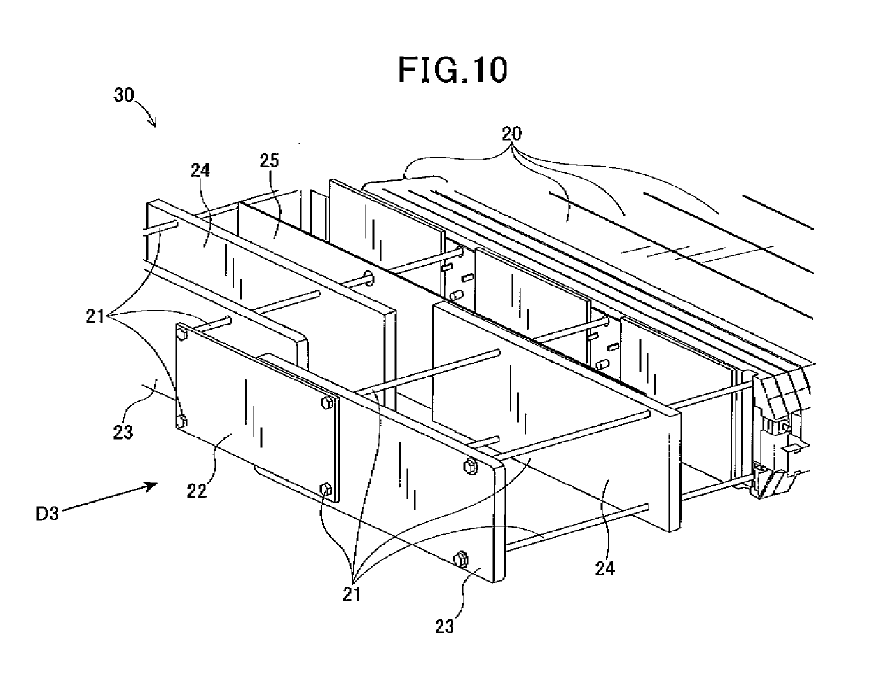

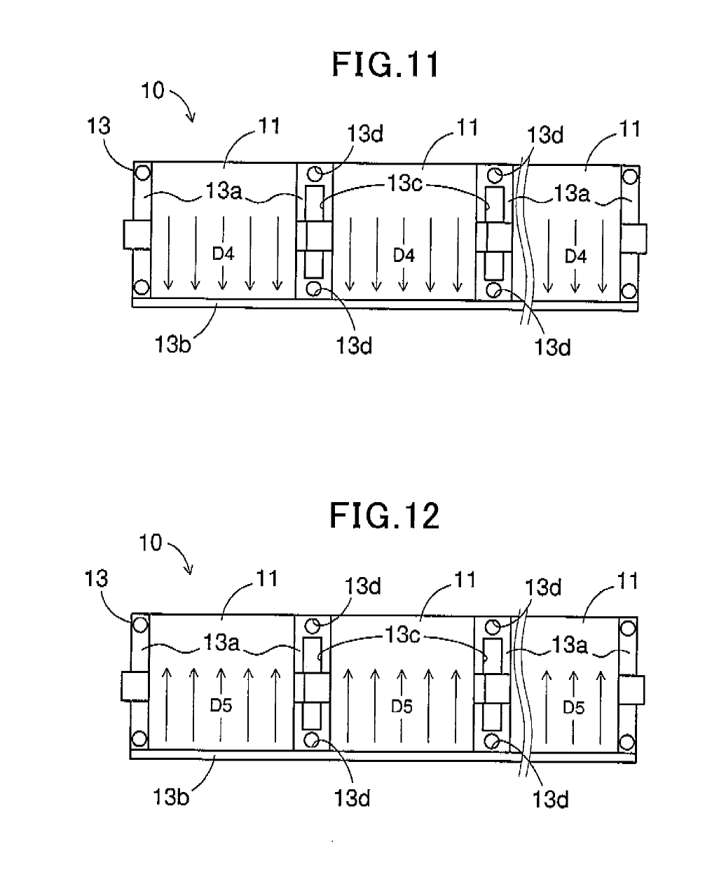

The transfer of heat in the battery pack 30 (especially, the sub-battery modules 10) will be discussed below with reference to FIGS. 11 and 12. FIGS. 11 and 12 are side illustrations of one of the sub-battery modules 10, as viewed in a direction indicated by an arrow D3 in FIG. 10.

FIG. 11 demonstrates heat transferring paths D4 when the heat exchanger 28 works to cool the battery cells 11 which have increased in temperature. FIG. 11 omits the heat exchanger 28 for the brevity of illustration. The heat, as generated by the battery cells 11, is conducted in a direction (i.e. downward as viewed in the drawing) perpendicular to the length of the thermal conductive wall 13b. The distance the heat moves is much shorter than the length of the thermal conductive wall 13b, thus resulting in uniformity of temperature over the whole of each of the battery cells 11. The rise in temperature of the battery cells 11 usually results from an increase in ambient temperature (e.g., the temperature of air) around the battery cells 11 or input or output of electric power into or from the battery cells 11.

FIG. 12 demonstrates heat transferring paths D5 when the heat exchanger 28 works to warm the battery cells 11 which have decreased in temperature. FIG. 12 omits the heat exchanger 28 for the brevity of illustration. The heat, as generated by the battery cells 11, is conducted in a direction (i.e. upward as viewed in the drawing) perpendicular to the length of the thermal conductive wall 13b. The distance the heat moves is much shorter than the length of the thermal conductive wall 13b, thus resulting in uniformity of temperature over the whole of each of the battery cells 11. The drop in temperature of the battery cells 11 usually results from a decrease in ambient temperature (e.g., the temperature of air) around the battery cells 11.

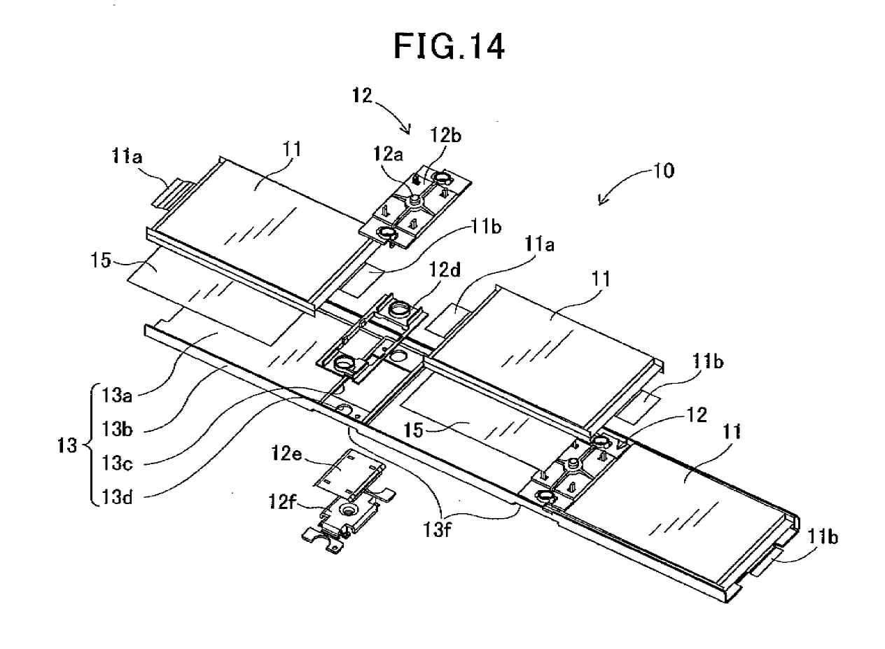

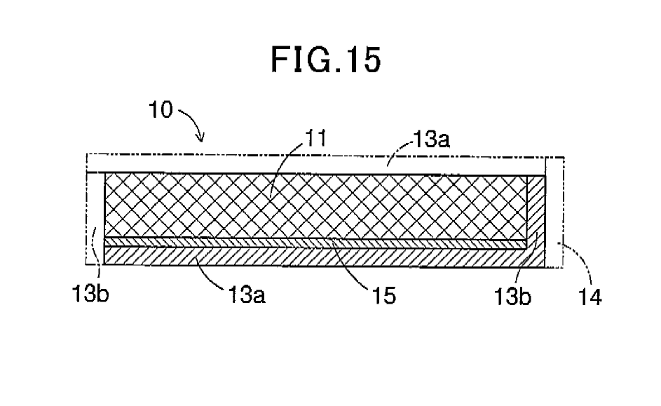

Each of the sub-battery modules 10 may be, as illustrated in FIGS. 14 and 15, equipped with sheets 15 each of which is interposed between one of the battery cells 11 and the plate 13. The sheets 15 are made of a high-thermal conductive material such as graphite. Such material may be higher in thermal conductivity than that of the plates 13.

The above embodiment offers the following beneficial advantages.

(1) The thermal conductive mechanism of the battery module 20 is, as described above, designed to have the plate 13 in each of the sub-battery modules 10. The plate 13 has outer surfaces (preferably even surfaces) which extend horizontally in the lengthwise-direction thereof and with which the planar surfaces of the respective battery cells 11 are placed in contact to facilitate the transfer of heat from the plate 13 to the battery cells 11 or vice versa. In other words, the plate 13 works to equalize the temperature in each of the battery cells 11 and also to minimize a difference in temperature among the battery cells 11, thus resulting in improvement of the performance of the battery cells 11 (i.e., the sub-battery modules 10).
(2) The plate 13 has, as clearly illustrated in FIGS. 11 and 12, the thermal conducive wall 13b placed in contact with one of side surfaces of each of the battery cells 11 which are opposed in the width-wise direction thereof. The thermal conductive wall 13b is in direct or indirect contact with the heat exchanger 28. Specifically, the heat exchanger 28 works to achieve the transfer of heat between itself and the plate 13 through the thermal conducive wall 13b, thereby permitting each or all of the battery cells 11 to be kept at a given temperature to ensure the stability in operation of the battery cells 11.
(3) The terminals 11a and 11b which are used as joints in connecting adjacent two of the battery cells 11 together are, as can be seen in FIGS. 1 to 3, 6, and 7, disposed on end surfaces of each of the battery cells 11 which are opposed to each other in the lengthwise direction thereof (i.e., a direction of alignment of the battery cells 11 on the plate 13), thus eliminating the physical interference with the thermal conducive wall 13b and permitting the thermal conductive wall 13b to have an increased surfaces. This increases the efficiency in keeping each or all of the battery cells 11 at a desired temperature to ensure the stability in operation of the battery cells 11.
(4) The terminals 11a and 11b which are used as joints in connecting adjacent two of the battery cells 11 together are, as can be seen in FIGS. 1 to 3, 6, and 7, designed to permit the heat to be transferred to or from the plate 13, thereby minimizing, like the battery cells 11, a variation in temperature of the terminals 11a and 11b, which improves the performance of the battery cells 11.
(5) The plate 13 has the first holes 13c which coincide with the terminals 11a and 11b of the respective battery cells 11 in the thickness-wise direction of the sub-battery module 10. The first holes 13c are used to facilitate joining of the terminal 11b of one of the battery cells 11 to the terminal 11a of an adjacent one of the battery cells 11.
(6) Each of the sub-battery modules 10 is equipped with the heat-transfer mechanisms 12 to establish the transfer of heat from the terminals 11a and 11b to the plate 13 or vice versa. Specifically, the heat-transfer mechanisms 12 serve to keep the terminals 11a and 11b at a desired temperature, thus resulting in improvement of the performance of the battery cells 11 (i.e., the sub-battery modules 10).
(7) The sub-battery module 10 has the insulating resinous plates 12b and 12d and the insulating cover 12e, as illustrated in FIGS. 6 and 7, disposed between the plate 13 and the terminals 11a and 11b, thereby electrically insulating therebetween. The insulating resinous plates 12b and 12d and the insulating cover 12e also serve to cover the terminals 11a and 11b and protect them from any physical impact.
(8) The sub-battery module 10 also includes, as illustrated in FIGS. 6 and 7, the damping plate 12c which works as a vibration absorber to suppress mechanical vibration of the terminals 11a and 11b, thus ensuring the stability of connection between the terminals 11a and 11b.
(9) The damping plate 12c is made totally or partially of an elastic material such as resin or rubber, thus enhancing the absorption of vibration of the terminals 11a and 11b. the damping plate 12c may alternatively be formed by a plate spring made of, for example, metal, not resin.
(10) Each of the plates 13 also includes, as illustrate in FIGS. 8 and 9, the second holes 13d through which the binding members 21 pass. The binding members 12 are used to bind the sub-battery modules 10 into a stack.
(11) The heat-transfer mechanism 12 has, as illustrated in FIG. 7, the third holes 12da and 12g which coincide with the second holes 13d in the thickness-wise direction of the heat-transfer mechanism 12. The binding members 21 pass through the second holes 13d and the third holes 12da and 12g to retain the battery modules 10 firmly.
(12) The binding members 12, as described above in FIG. 7, pass through the second holes 13d and the third holes 12da and 12g which are aligned with each other, thereby ensuring tight retaining of the sub-battery modules 10 as a stack. The binding members 12 may be inserted into either of the second holes 13d or the third holes 12da and 12g depending upon the size or configuration of the body 13a, the insulating resin plates 12b or the thermal conductive member 12f. This also achieves the tight retaining of the sub-battery modules 10.
(13) The plate 13 has, as illustrated in FIGS. 2 and 3, the recesses 13e in which the battery cells 11 are disposed. This facilitates the positioning and mounting of the battery cells 11 on the plate 13, thus resulting in improved workability in assembling each of the sub-battery modules 10 or the battery pack 30. The plate 13 may be designed to have protrusion(s) shaped to position and retain the battery cells instead of the recesses 13e or a combination of such protrusions and the recesses 13e.
(14) Each of the battery cells 11 is a lithium-ion cell or a lithium secondary cell. The material of the positive electrode of the battery cells 11 is a polyanionic material such as LiMPO₄ or Li₂MSiO₄ and contains as a metallic element (M) one or more of manganese (Mn), ion (Fe), cobalt (Co), and Nickel (Ni). This ensures the safety of the battery cell 11 against, for example, overheating thereof.

The lithium secondary cell may include a cathode active material, an anode active material that is material working to absorb or desorb lithium ions or a metallic lithium, and an electrolytic substance which achieves transfer of lithium ions for electrochemical reaction with either or both of the cathode active material and the anode active material. The cathode active material may be a polyanionic lithium metal oxide containing lithium, one or more metallic elements selected from a group of transition metal elements, silicon or phosphorus, and oxygen.

(15) Each of the battery cells 11 is of a laminated type, as can be seen in FIG. 1. Such a type of battery cells 11 are excellent in thermal conductivity, thus facilitating the transfer of heat to or from the battery cells 11 when subjected to a variation in internal temperature. This equalizes the temperature in each of the battery cells 11 and also to minimizes a difference in temperature among the battery cells 11.
(16) Each of the sub-battery modules 10, as can be seen from FIGS. 14 and 15, may have the sheets 15 each of which is interposed between one of the battery cells 11 and the plate 13. The sheets 15 serve to minimize the ununiformity of temperature in each of the battery cells 11, thus permitting the sub-battery modules 10 or the battery module 20 to be reduced in size. Instead of the sheets 15, plate members may be used.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims. For instance, the above embodiment may be modified as discussed below.

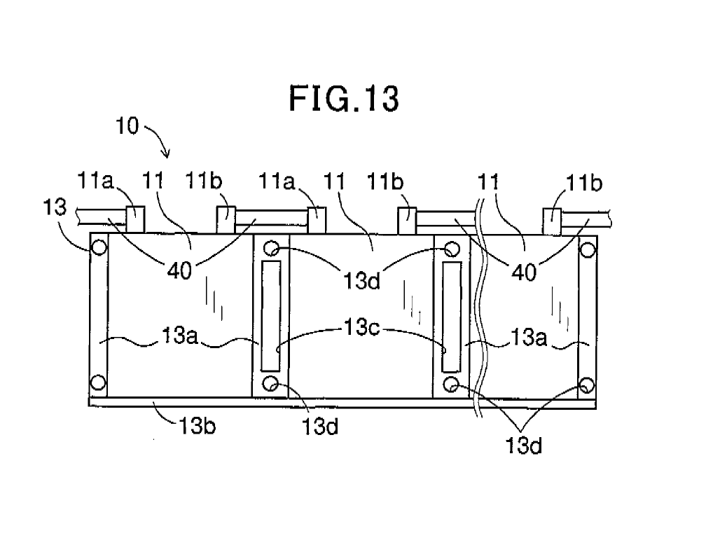

The terminals 11a and 11b, as described above, extend from the ends of each of the battery cell 11 which are opposed to each other in the lengthwise direction of the sub-battery module 11, but may alternatively be, as illustrated in FIG. 13, mounted on either of the side walls of each of the battery cells 11. The connection between the terminals 11a and 11b of adjacent two of the battery cells 11 requires a conductive wire 40, but the layout of the terminals 11a and 11b eliminates the need for the second holes 13d for use in joining the terminals 11a and 11b disposed as illustrated in FIG. 1. The layout of the terminals 11a and 11b of FIG. 13 does not disturb the transfer of heat, as indicated by the arrows D4 in FIG. 11, to cool the battery cells 11 or, as indicated by the arrows D5 in FIG. 12, to warm the battery cells 11.

Each of the battery cells 11 is, as described above, a laminated lithium-ion battery. The material of the positive electrode of the battery cells 11 is polyanionic material, i.e., lithium metal oxide. Each of the battery cells 11 may alternatively be of a non-laminated type. The material of the positive electrode of the battery cells 11 may be other than polyanionic material or lithium metal oxide. In the case of such a type of battery cells 11, the structure of the sub-battery module 10 works to achieve the transfer of heat, as indicated by the arrows D4 in FIG. 11, to cool the battery cells 11 or as indicated by the arrows D5 in FIG. 12, to warm the battery cells 11.

Each of the heat-transfer mechanisms 12 is, as described above, equipped with the protrusion 12a, the insulating resinous plates 12b and 12d, the thermal conductive member 12f, the damping plate 12c, and the insulating cover 12e. At least one (not all) of the protrusion 12a, the insulating resinous plates 12b and 12d, the thermal conductive member 12f, the damping plate 12c, and the insulating cover 12e. Any two or more of the protrusion 12a, the insulating resinous plates 12b and 12d, the thermal conductive member 12f, the damping plate 12c, and the insulating cover 12e may be made of thermoplastic material or thermosetting material and fused by heat totally or partially to make a single piece unit as long as the heat-transfer mechanisms 12 have the thermal conductivity.

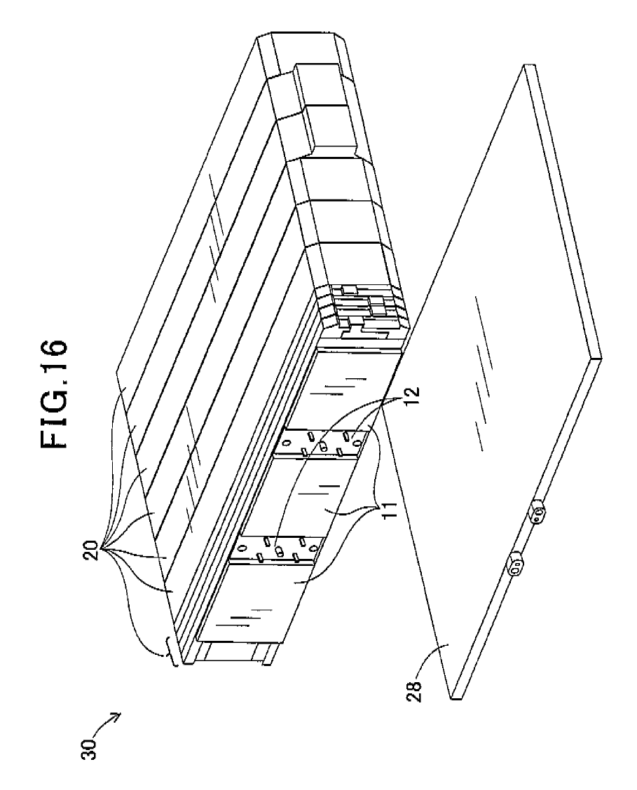

The plate 13, as illustrated in FIG. 1, has the thermal conductive wall 13b which is, as can be seen from FIG. 9, placed in indirect contact with the heat exchanger 28, but may alternatively be disposed, as illustrated in FIG. 16, in direct contact with the heat exchanger 28. This also equalizes the temperature in each of the battery cells 11 and also minimizes a difference in temperature among the battery cells 11.

What is claimed is:

1. A thermal conductive mechanism for a battery pack made up of a stack of a plurality of sub-battery modules each of which includes a plurality of battery cells arrayed thereon, the sub-battery modules each having opposed major surfaces and being laid to overlap each other in a direction perpendicular to the major surfaces, comprising:
plates provided one for each of the sub-battery modules, each of the plates having a given number of the battery cells disposed thereon; and
heat transfer surfaces formed on each of the plates and arrayed in a planar direction of the plates, the heat transfer surfaces being placed in one of direct and indirect surface-contact with the given number of the battery cells to achieve transfer of heat therebetween.

2. A thermal conductive mechanism as set forth in claim 1, wherein the battery cells are arrayed in alignment with each other on each of the plates, and wherein each of the plates has a thermal conductive wall extending in a direction of the alignment of the battery cells, the thermal conductive wall being placed in direct or indirect surface-contact with a heat exchanger.

3. A thermal conductive mechanism as set forth in claim 2, wherein the battery cells are joined together on each of the plates, joints of the battery cells being located between surfaces of the battery cells which are opposed to each other in the direction of the alignment of the battery cells,

4. A thermal conductive mechanism as set forth, in claim 3, wherein the joints work to achieve transfer of heat between themselves and the plates,

5. A thermal conductive mechanism as set forth in claim 4, wherein each of the plates has formed therein first holes which coincide with, the joints, respectively.

6. A thermal conductive mechanism as set forth in claim 5, further comprising a heat transfer mechanism working to establish conduction of heat between the joints and each of the plates.

7. A thermal conductive mechanism as set forth in claim 4, further comprising electric insulators interposed between each of the plates and the joints to electrically insulate therebetween.

8. A thermal conductive mechanism as set forth in claim 4, further comprising a damper which works to absorb vibration of the joints.

9. A thermal conductive mechanism as set forth in claim 8, wherein the damper is made of an elastic member.

10. A thermal conductive mechanism as set forth in claim 1, wherein each of the plates has second holes through which binding members pass to bind the sub-battery modules into a stack.

11. A thermal conductive mechanism as set forth in claim 10, further comprising a heat transfer mechanism working to establish conduction of heat between joints of the battery cells, and wherein the heat transfer mechanism has third holes coinciding with the second holes.

12. A thermal conductive mechanism as set forth in claim 1, further comprising binding members and a heat transfer mechanism working to establish conduction of heat between joints of the battery cells, wherein each of the plates has second holes, and the heat transfer mechanism has third holes coinciding with the second holes, and wherein the binding members pass through the second holes and/or the third holes to bind the sub-battery modules into a stack.

13. A thermal conductive mechanism as set forth in claim 1, wherein each of the plates has formed therein recesses or protrusions which position the battery cells on the plate.

14. A thermal conductive mechanism as set forth in claim 1, wherein each of the battery cells is a lithium secondary cell which includes a cathode active material, an anode active material that is material working to absorb or desorb lithium ions or a metallic lithium, and an electrolytic substance which achieves transfer of lithium ions for electrochemical reaction with either or both of the cathode active material and the anode active material, and wherein the cathode active material is a polyanionic lithium metal oxide containing lithium, one or more metallic elements selected from a group of transition metal elements, silicon or phosphorus, and oxygen.

15. A thermal conductive mechanism as set forth in claim 1, wherein each of the battery cells is of a laminated type.

16. A thermal conductive mechanism as set forth in claim 1, further comprising a sheet or a plate member which is disposed between each of the plates and each of the battery cells and higher in thermal conductivity than the plates.
